(19) United States
(12) Patent Application Publication
(10) Pub. No.: US 2023/0394860 A1
(43) Pub. Date: Dec. 7, 2023

(54) VIDEO-BASED SEARCH RESULTS WITHIN A COMMUNICATION SESSION

(71) Applicant: Zoom Video Communications, Inc., San Jose, CA (US)

(72) Inventors: Renjie Tao, Sunnyvale, CA (US); Ling Tsou, Lawndale, CA (US)

(21) Appl. No.: 17/832,642

(22) Filed: Jun. 4, 2022

(51) Int. Cl. G06V 30/19; G06V 10/62; G06V 20/62; G06V 20/40; G06V 10/70; G06V 30/14; G06F 16/783; G06F 16/738

(52) U.S. Cl. CPC G06V 30/19013; G06V 10/62; G06V 20/62; G06V 20/41; G06V 10/768; G06V 30/1444; G06F 16/7844; G06F 16/738; H04L 65/403

(57) ABSTRACT

Methods and systems provide for video-based search results within a communication session. In one embodiment, the system receives video content of a communication session with a number of participants; extracts, via optical character recognition (“OCR”), textual content from the frames of the video content, each piece of textual content including a timestamp representing a temporal location of the frame within the video content; receives, from a client device associated with a user, a request to search for specified text within the video content; in response to receiving the request, determines one or more matching pieces of textual content which match to the specified text; and presents, to the client device, the matching pieces of textual content.

### FIELD OF INVENTION

The present invention relates generally to digital communication, and more particularly, to systems and methods for providing video-based search results within a communication session.

### SUMMARY

The appended claims may serve as a summary of this application.

### BRIEF DESCRIPTION OF THE DRAWINGS

The present invention relates generally to digital communication, and more particularly, to systems and methods for providing video-based search results within a communication session

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2 is a flow chart illustrating an exemplary method that may be performed in some embodiments.

FIG. 3A is a diagram illustrating one example embodiment of a distinguishing frame containing text.

FIG. 3B is a diagram illustrating one example embodiment of an extracted title and extracted textual content from a distinguishing frame containing text.

FIG. 4A is a diagram illustrating an example embodiment of a video-based search result presented within a video frame.

FIG. 4B is a diagram illustrating an example embodiment of a video-based search result presented within textual content.

FIG. 5 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

Digital communication tools and platforms have been essential in providing the ability for people and organizations to communicate and collaborate remotely, e.g., over the internet. In particular, there has been massive adopted use of video communication platforms allowing for remote video sessions between multiple participants. Video communications applications for casual friendly conversation (“chat”), webinars, large group meetings, work meetings or gatherings, asynchronous work or personal conversation, and more have exploded in popularity.

With the ubiquity and pervasiveness of remote communication sessions, a large amount of important work for organizations gets conducted through them in various ways. For example, a large portion or even the entirety of sales meetings, including pitches to prospective clients and customers, may be conducted during remote communication sessions rather than in-person meetings. Sales teams will often dissect and analyze such sales meetings with prospective customers after they are conducted. Because sales meetings may be recorded, it is often common for a sales team to share meeting recordings between team members in order to analyze and discuss how the team can improve their sales presentation skills.

Such techniques are educational and useful, and can lead to drastically improved sales performance results for a sales team. However, such recordings of meetings simply include the content of the meeting, and the communications platforms which host the meetings do not provide the sorts of post-meeting, or potentially in-meeting, intelligence and analytics that such a sales team would find highly relevant and useful to their needs.

Particularly, when navigating through recorded video of a communication session, reviewing a sales meeting can be difficult and time consuming, as sales meeting can often run for 30-60 minutes, and a large amount of time is often spent on scrolling through the meeting to find the portion or topic the user is looking for. Additionally, past sales meetings can be difficult to search for, as there is no way to search for specific content, including titles of presentation slides and textual content presented in presentation slides.

Thus, there is a need in the field of digital communication tools and platforms to create a new and useful system and method for providing video-based search results within a communication session. The source of the problem, as discovered by the inventors, is a lack of ability to search for text from slides and other content within a video and receive results within a matching frame or matching extracted text.

In one embodiment, the system receives video content of a communication session with a number of participants; extracts, via optical character recognition (“OCR”), textual content from the frames of the video content, each piece of textual content including a timestamp representing a temporal location of the frame within the video content; receives, from a client device associated with a user, a request to search for specified text within the video content; in response to receiving the request, determines one or more matching pieces of textual content which match to the specified text; and presents, to the client device, the matching pieces of textual content.

Further areas of applicability of the present disclosure will become apparent from the remainder of the detailed description, the claims, and the drawings. The detailed description and specific examples are intended for illustration only and are not intended to limit the scope of the disclosure.

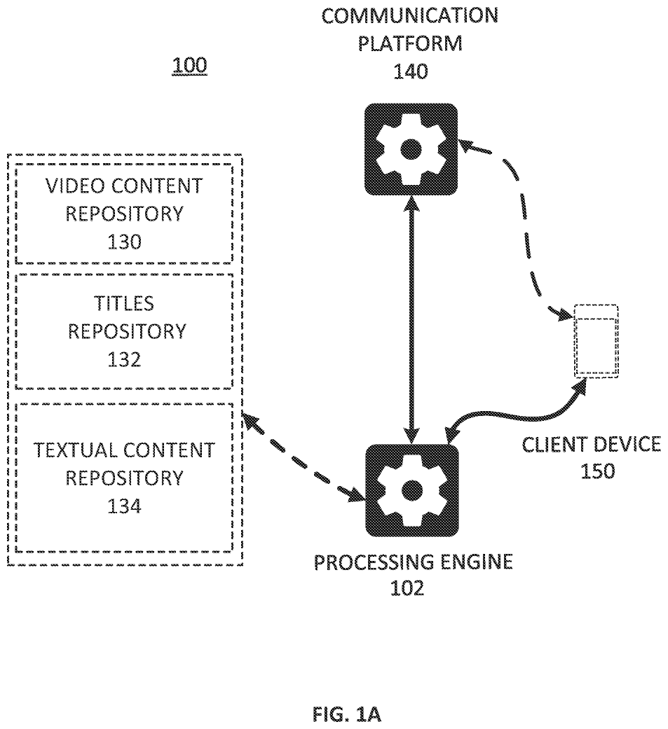

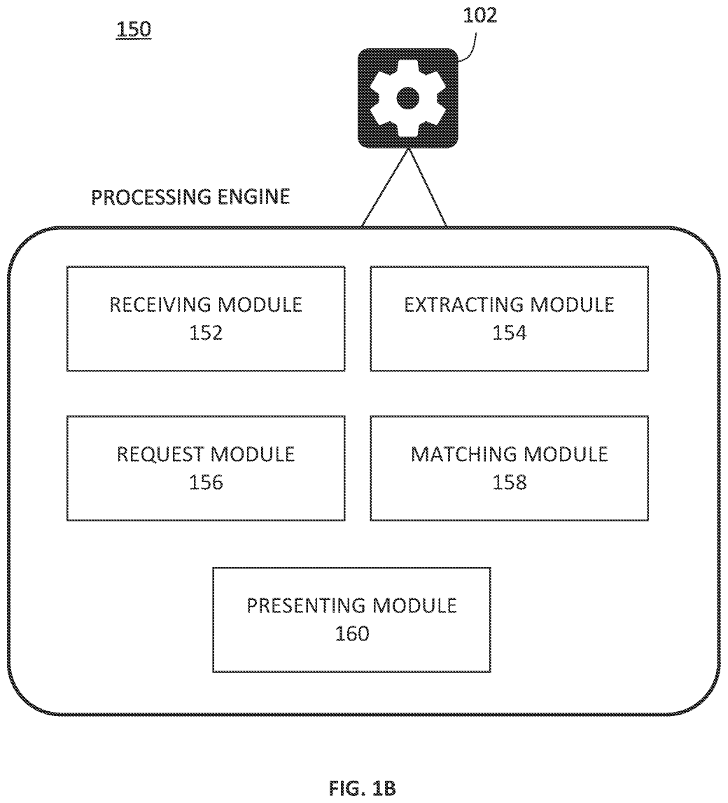

FIG. 1A is a diagram illustrating an exemplary environment in which some embodiments may operate. In the exemplary environment 100, a client device 150 is connected to a processing engine 102 and, optionally, a communication platform 140. The processing engine 102 is connected to the communication platform 140, and optionally connected to one or more repositories and/or databases, including, e.g., a video content repository 130, titles repository 132, and/or textual content repository 134. One or more of the databases may be combined or split into multiple databases. The user's client device 150 in this environment may be a computer, and the communication platform 140 and processing engine 102 may be applications or software hosted on a computer or multiple computers which are communicatively coupled via remote server or locally.

The exemplary environment 100 is illustrated with only one client device, one processing engine, and one communication platform, though in practice there may be more or fewer additional client devices, processing engines, and/or communication platforms. In some embodiments, the client device(s), processing engine, and/or communication platform may be part of the same computer or device.

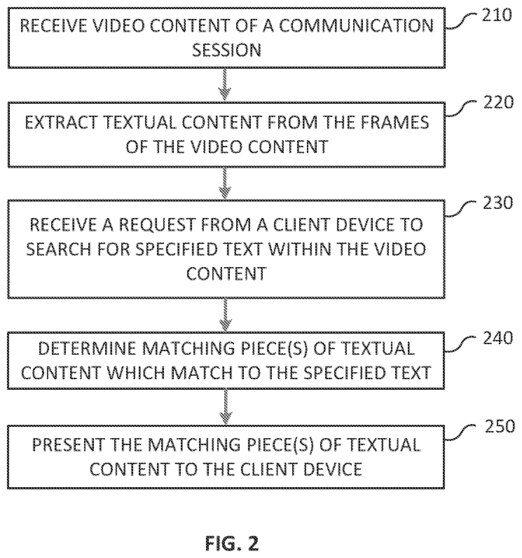

In an embodiment, the processing engine 102 may perform the exemplary method of FIG. 2 or other method herein and, as a result, provide video-based search results within a communication session. In some embodiments, this may be accomplished via communication with the client device, processing engine, communication platform, and/or other device(s) over a network between the device(s) and an application server or some other network server. In some embodiments, the processing engine 102 is an application, browser extension, or other piece of software hosted on a computer or similar device, or is itself a computer or similar device configured to host an application, browser extension, or other piece of software to perform some of the methods and embodiments herein.

The client device 150 is a device with a display configured to present information to a user of the device who is a participant of the video communication session. In some embodiments, the client device presents information in the form of a visual UI with multiple selectable UI elements or components. In some embodiments, the client device 150 is configured to send and receive signals and/or information to the processing engine 102 and/or communication platform 140. In some embodiments, the client device is a computing device capable of hosting and executing one or more applications or other programs capable of sending and/or receiving information. In some embodiments, the client device may be a computer desktop or laptop, mobile phone, virtual assistant, virtual reality or augmented reality device, wearable, or any other suitable device capable of sending and receiving information. In some embodiments, the processing engine 102 and/or communication platform 140 may be hosted in whole or in part as an application or web service executed on the client device 150. In some embodiments, one or more of the communication platform 140, processing engine 102, and client device 150 may be the same device. In some embodiments, the user's client device 150 is associated with a first user account within a communication platform, and one or more additional client device(s) may be associated with additional user account(s) within the communication platform.

In some embodiments, optional repositories can include a video content repository 130, title repository 132, and/or textual content repository 134. The optional repositories function to store and/or maintain, respectively, video content for the communication session; extracted titles from frames of the video content; and extracted textual content from frames of the video content. The optional database(s) may also store and/or maintain any other suitable information for the processing engine 102 or communication platform 140 to perform elements of the methods and systems herein. In some embodiments, the optional database(s) can be queried by one or more components of system 100 (e.g., by the processing engine 102), and specific stored data in the database(s) can be retrieved.

Communication platform 140 is a platform configured to facilitate meetings, presentations (e.g., video presentations) and/or any other communication between two or more parties, such as within, e.g., a video conference or virtual classroom. A video communication session within the communication platform 140 may be, e.g., one-to-many (e.g., a participant engaging in video communication with multiple attendees), one-to-one (e.g., two friends remotely communication with one another by video), or many-to-many (e.g., multiple participants video conferencing with each other in a remote group setting).

FIG. 1B is a diagram illustrating an exemplary computer system 150 with software modules that may execute some of the functionality described herein. In some embodiments, the modules illustrated are components of the processing engine 102.

Receiving module 152 functions to receive video content of a communication session with a number of participants.

Extracting module 154 functions to extract, via optical character recognition (OCR), textual content from the frames of the video content, each piece of textual content including a timestamp representing a temporal location of the frame within the video content.

Request module 156 functions to receive, from a client device associated with a user, a request to search for specified text within the video content.

Matching module 158 functions, in response to receiving the request, to determine one or more matching pieces of textual content which match to the specified text.

Presenting module 160 functions to present, to the client device, the matching pieces of textual content.

The above modules and their functions will be described in further detail in relation to an exemplary method below.

FIG. 2A is a flow chart illustrating an exemplary method that may be performed in some embodiments.

At step 210, the system receives video content of a communication session which includes a number of participants. In various embodiments, a communication session may be, e.g., a remote video session, audio session, chat session, or any other suitable communication session between participants. In some embodiments, the communication session can be hosted or maintained on a communication platform, which the system maintains a connection to in order to connect to the communication session. In some embodiments, the system displays a user interface (“UI”) for each of the participants in the communication session. The UI can include one or more participant windows or participant elements corresponding to video feeds, audio feeds, chat messages, or other aspects of communication from participants to other participants within the communication session.

The video content the system receives is any recorded video content that captures the communication session. The video content can include any content that is shown within the communication session, including, e.g., video feeds showing participants, presentation slides which are presented during the session, screens, desktops, or windows which are shared, annotations, or any other suitable content which can be shared during a communication session. The video content is composed of a multitude of frames. In some embodiments, the system receives the video content from a client device which was used by a participant to connect to the communication session. In some embodiments, the video content is generated by a client device, or the system itself, during and/or after the communication session. In some embodiments, video content of a session may be recorded upon a permitted participant, such as a host of the session, selecting one or more “record” options from their user interface. In other embodiments, the video content may be recorded automatically based on a user's preferences.

At step 220, the system processes the video content to extract one or more pieces of textual content visible within the frames of the video content. In some embodiments, this extraction of textual content is performing using optical character recognition (“OCR”). In some embodiments, the system further processes the video content to extract, via OCR, one or more titles visible within the frames of the video content.

In some embodiments, as part of this textual extraction, the system performs one or more of the following: extracting frames from the video content; classifying the frames using a frame classifier; identifying one or more distinguishing frames; detecting a title within each distinguishing frame; cropping a title area within the frame; extracting a title from the cropped title area via OCR; extracting textual content from distinguishing frames via OCR; and transmitting the extracted textual content and extracted titles to one or more client devices and/or elsewhere within the system. In some embodiments, low-resolution and high-resolution versions of frames may be extracted, and a process for analyzing low-resolution frames and extracting from high-resolution versions of those frames may be performed to allow for a faster, more efficient extraction of textual content. In some embodiments, one or more frames may be filtered out if they do not contain text, or if they are frames of a type which does not contain text (i.e., black frames or face frames). In some embodiments, a title may be detected within a distinguishing frame based on a You Only Look Once (YOLO) model or similar model.

In some embodiments, the system extracts frames from the video content. In some embodiments, extracting frames involves the system generating a thumbnail for each frame, with the thumbnail being used as the frame for the purposes of this method. In some embodiments, an asynchronous thumbnail extraction service may be queried, and may function to generate individual thumbnail frames, then downsize them (for example, the service may downsize the frame by 10 times). The thumbnail extraction service may further aggregate the individual thumbnail frames into tiles (for example, to a grid of 5×5 tiles). In some embodiments, the resulting thumbnails may then be uploaded to an image server, where they can then be retrieved for further processing.

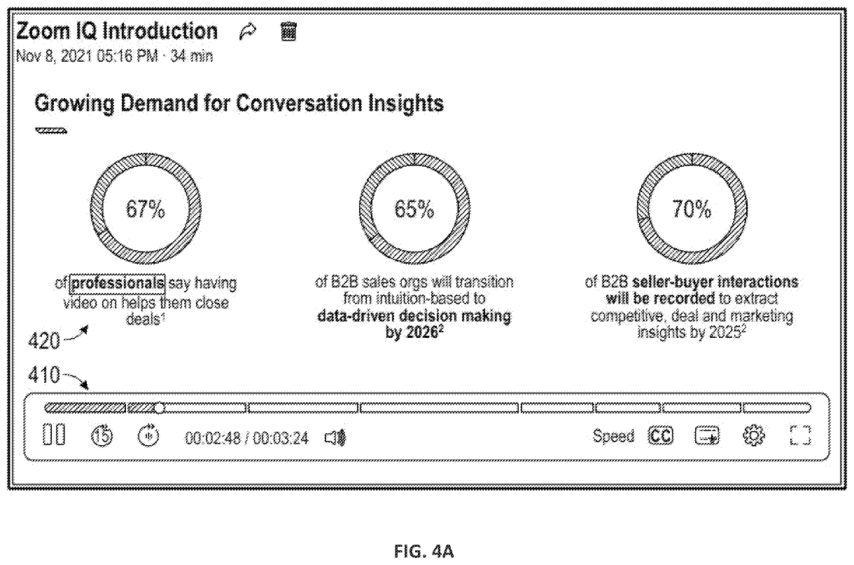

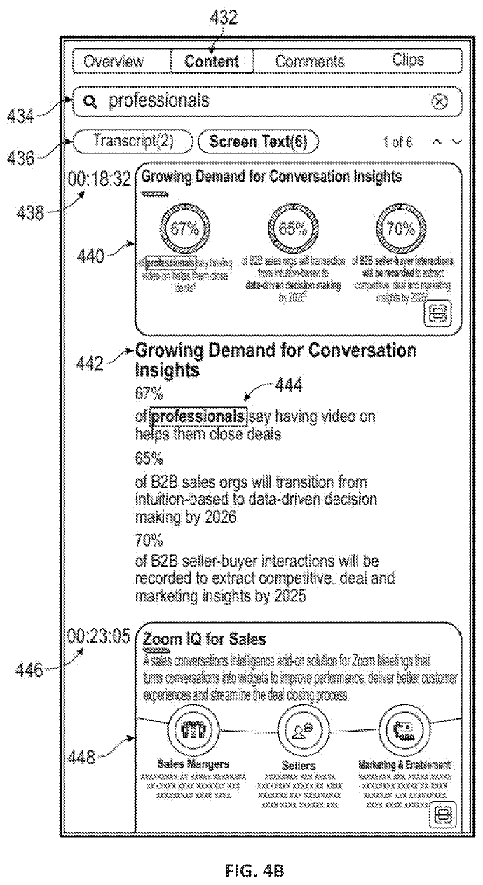

In some embodiments, the system classifies frames of the video content. In some embodiments, a frame classifier may be used. By classifying video frames into a number of categories, e.g., 4 categories, consecutively-same frames of video can be grouped within a single segment. In some embodiments, the categories may include black frames (i.e., empty or devoid of content), face frames (i.e., frames where faces of participants are shown via their respective video feeds), slide frames (i.e., frames in which presentation slides are being presented), and demo frames (i.e., frames where a demonstration of a product, technique, or similar is being presented). Face frames may be used to analyze the sentiment and/or engagement of participants. Slide and demo frames may be used to analyze, for example, the duration of product demonstrations in a sales meeting. Slide and demo frames which contain text may also be used for various natural language parsing projects after OCR is performed, among other things. Examples of such frame classifications are described below with respect to FIG. 4.

In some embodiments, a neural network may be used to classify the frames of the video content. In some embodiments, a convolutional neural network (CNN) may be used.

In some embodiments, the system identifies one or more distinguishing frames containing text. The identification process involves finding a distinguishing frame, or key frame, which indicates new or changed content in comparison to its previous neighboring frame.

In some embodiments, for each distinguishing frame containing text, the system detects a title within the frame. In other words, the system detects that a title is present within the frame. At this step, the system does not yet extract the title from the frame, but rather verifies that there is title text present. Thus, the system must recognize which text is the title within a frame containing text. Title detection is an object detection problem, which involves the task of detecting instances of objects of a certain class within a given image. In some embodiments, one-stage methods may be used which prioritize inference speed, such as, e.g., a You Only Look Once (“YOLO”) model. In some embodiments, two-stage methods may be used which prioritize detection accuracy, such as, e.g., Faster R-CNN.

In some embodiments, the system extracts, via OCR, the title from the cropped title area of the frame. OCR is a technology that is designed to recognize text within an image. In this case, an OCR model is used to extract the title text from the cropped title area. In various embodiments, OCR-based text extraction may involve such techniques as, e.g., feature extraction, matrix matching, layout analysis, iterative OCR, lexicon-based OCR, near-neighbor analysis, binarization, character segmentation, normalization, or any other suitable techniques related to OCR.

In some embodiments, the system extracts, via OCR, textual content from the distinguishing frames containing text. Once the titles have been extracted from particular distinguishing frames containing text, then the system can proceed to capture the textual content in full from such frames. The same or different OCR-based text extraction techniques may apply, depending on various embodiments.

At step 230, the system receives a request to search for specified text within the video content. In some embodiments, a user interface is presented to a user of the client device. Within the user interface, a request window can be presented to the user which allows the user to request a search to be performed. In some embodiments, the request window allows a text field for entering one or more search terms, words, or phrases. In some embodiments, the request window enables the user to present the requested specified text verbally into a microphone capturing the user's voice. In some embodiments, one or more recommended search terms may be presented based on the extracted textual content and/or titles, and a user may select one of the recommended terms as the specified text. In some embodiments, at least a portion of the specified text includes one or more titles detected within the frames of the video content.

In some embodiments, the specified text within the request includes at least one of: one or more words, one or more phrases, one or more numbers, and one or more symbols. In some embodiments, the user may modify the specified text at any point to change the search and be presented with different search results.

At step 240, the system determines one or more matching pieces of textual content which match to the specified text. In varying embodiments, each of the matches may be determined based on an exact match, similarity match, fuzzy match, keyword match, any other suitable or relevant matching method, or any combination thereof. One or more known search engine methods may be employed in order to facilitate the matching. In some embodiments, the system determines one or more exact matches with a spell-corrected version of the specified text. In some embodiments, the system determines one or more non-exact matches with the specified text. In some embodiments, the non-exact match is based on entity extraction techniques. In some embodiments, the non-exact match is based on relationship embedding techniques. In some embodiments, the non-exact match is based on matching synonyms.

At step 250, the system presents, to the client device, the matching pieces of textual content. Varying embodiments may present the matching pieces of textual content in a variety of ways. In some embodiments, the matching content may be presented as in a traditional search engine displaying search results, with a number of results being displayed as the user scrolls down, and with some context or snippets of text around the matching text being provided as well. In some embodiments, a title detected within a frame may be presented along with the matching text. In some embodiments, a thumbnail of a frame with matching text in it may be presented.

In some embodiments, the system ranks the matching pieces of textual content based on a relevance score. The matching pieces of textual content are then presented by the system to the client device in order of ranking. In some embodiments, the relevance score is based on one or more of: the specified text, user preferences, user behavior, user search history, and popularity of the matching piece of textual content.

In some embodiments, the matching pieces of textual content are presented to the client device in chronological order based on the associated timestamps. That is, the timestamps which corresponds to temporal locations for each

In some embodiments, the system presents the frame associated with each matching piece of textual content, with the matching piece of textual content being visually highlighted within the presented frame. In some embodiments, the system presents the full textual content from the frame associated with each matching piece of textual content, the matching piece of textual content being visually highlighted within the presented full textual content. In some embodiments, the system presents one or more frames associated with the matching pieces of textual content and one or more pieces of textual content associated with the frames, the matching pieces of textual content being visually highlighted within the pieces of textual content associated with the frames.

In some embodiments, the system presents a subset of the textual content from the frame associated with each matching piece of textual content, the matching piece of textual content being visually highlighted within the presented subset of the textual content. In some embodiments, the system identifies, from the frame associated with each matching piece of textual content, a contextual portion of the textual content representing a context for the matching piece of textual content within a prespecified threshold distance from the matching piece of textual content. The presented subset of the textual content is the contextual portion of the textual content. In some embodiments, the presented subset is determined based on the available space within a window for presenting the subset.

In some embodiments, one or more excerpts of transcript text may be presented with matching pieces of textual content. In some embodiments, a user may opt to navigate between matching results within transcript text, matching results within frames, and matching results within extracted text; or may navigate between some combination thereof.

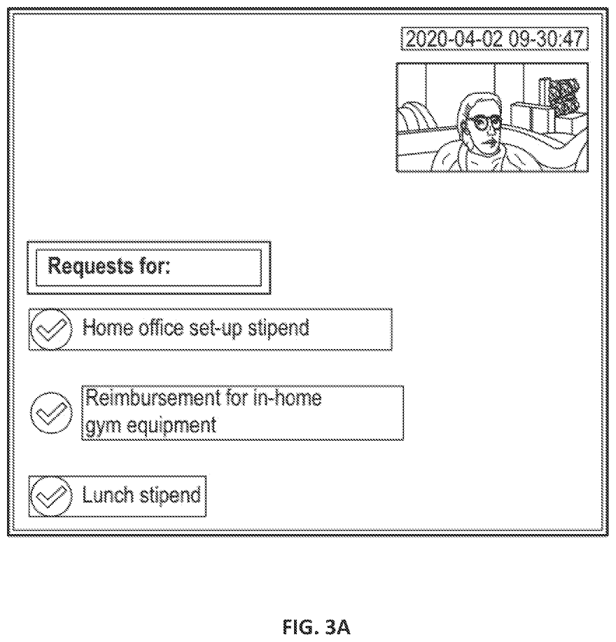

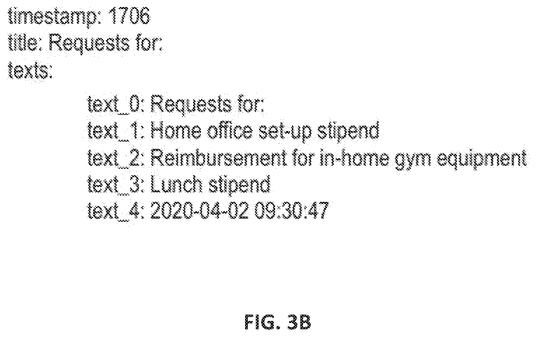

FIG. 3A is a diagram illustrating one example embodiment of a distinguishing frame containing text. In the illustrated example of a frame, a title is identified as “Requests for:” and a bounding box is generated around the title. Although a date is displayed in the top left corner, it is not recognized as a title. In some embodiments, the date and/or the thumbnail of the video feed in the top right corner are replacing with padding of a black rectangle.

FIG. 3B is a diagram illustrating one example embodiment of an extracted title and extracted textual content from a distinguishing frame containing text. The frame illustrated in FIG. 3C has its title and textual content extracted, which is presented along with a timestamp for the frame.

FIG. 4A is a diagram illustrating an example embodiment of a video-based search result presented within a video frame.

The illustrated example shows a search result being presented to a user of a client device. The search result shown is a frame of video content. The user presented a search request for a specific piece of video content for a communication session. The request included the specific text “professionals”, which the user selected as their requested search term. Within the presentation of the search result, a user interface for playback of the video content is presented, with playback controls 410. The video is skipped to a temporal location 2 minutes and 48 seconds into the video, where a first matching text “professionals” 420 is located within the presented frame of the video. The user has chosen to play back the video from this frame. The matching text “professionals” is visually highlighted within the search results. In some cases this may be a box or rectangle generated around the matching text. In other cases, the matching text may be highlighted with a specific color, such as yellow. In some embodiments, other search results may be navigable by the user using the playback controls as well.

FIG. 4B is a diagram illustrating an example embodiment of a video-based search result presented within textual content.

The illustrated example shows search results being presented to a user within a user interface. Three tabs at the top are displayed, including the current tab 432 marked “Content”. This tab presents the content of search results. A search field 434 is also presented, wherein the user can type in search terms or modify current search terms. The user may also be presented with either a transcript or screen text in section 436. In this case, “screen text” is highlighted. A number next to “transcript” shows that there are 2 matching results within the transcript for the session, and a number next to “screen text” shows that they are 6 matching results within the screen text for the session. A timestamp 438 is presented for a first matching result, showing that the screen text presented correlates to that specific time within the video. A timestamp 446 of a second matching result correlates to a later time, because the search results are presented in chronological order. A frame 440 is presented, with the frame showing matching text for “professionals” visually highlighted. Below the frame, extracted text from the frame is presented. Within the extracted text, a title 442 is presented, as well as the matching text 444. Below the first matching result, the second matching result shows a second frame 448. The user may scroll down within the user interface to see further search result content.

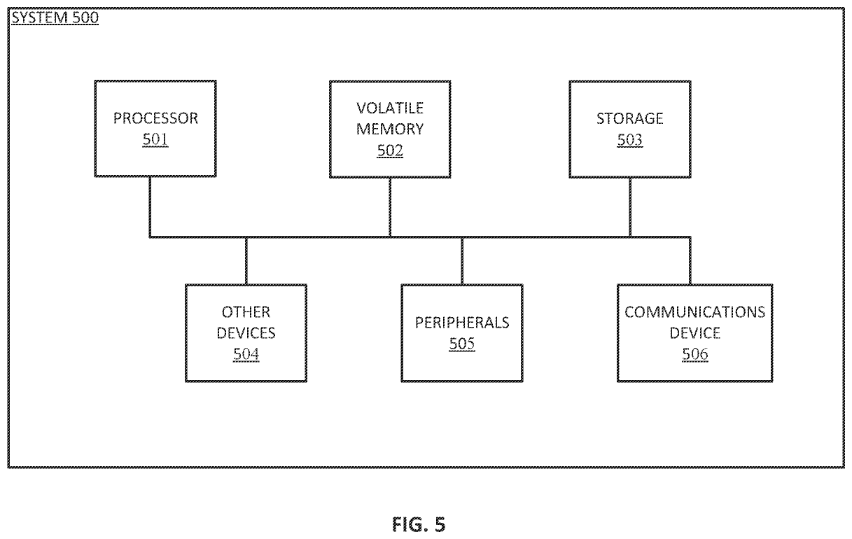

FIG. 5 is a diagram illustrating an exemplary computer that may perform processing in some embodiments. Exemplary computer 500 may perform operations consistent with some embodiments. The architecture of computer 500 is exemplary. Computers can be implemented in a variety of other ways. A wide variety of computers can be used in accordance with the embodiments herein.

Processor 501 may perform computing functions such as running computer programs. The volatile memory 502 may provide temporary storage of data for the processor 501. RAM is one kind of volatile memory. Volatile memory typically requires power to maintain its stored information. Storage 503 provides computer storage for data, instructions, and/or arbitrary information. Non-volatile memory, which can preserve data even when not powered and including disks and flash memory, is an example of storage. Storage 503 may be organized as a file system, database, or in other ways. Data, instructions, and information may be loaded from storage 503 into volatile memory 502 for processing by the processor 501.

The computer 500 may include peripherals 505. Peripherals 505 may include input peripherals such as a keyboard, mouse, trackball, video camera, microphone, and other input devices. Peripherals 505 may also include output devices such as a display. Peripherals 505 may include removable media devices such as CD-R and DVD-R recorders/players. Communications device 506 may connect the computer 100 to an external medium. For example, communications device 506 may take the form of a network adapter that provides communications to a network. A computer 500 may also include a variety of other devices 504. The various components of the computer 500 may be connected by a connection medium such as a bus, crossbar, or network.

It will be appreciated that the present disclosure may include any one and up to all of the following examples.

Example 1. A method, comprising: receiving video content of a communication session between a plurality of participants; extracting, via optical character recognition (OCR), a plurality of textual content from the frames of the video content, each piece of textual content comprising a timestamp representing a temporal location of the frame within the video content; receiving, from a client device associated with a user, a request to search for specified text within the video content; in response to receiving the request, determining one or more matching pieces of textual content which match to the specified text; and presenting, to the client device, the matching pieces of textual content.

Example 2. The method of example 1, wherein at least a subset of the plurality of textual content comprises one or more titles detected within the frames of the video content.

Example 3. The method of any of examples 1-2, wherein the specified text within the request comprises at least one of: one or more words, one or more phrases, one or more numbers, and one or more symbols.

Example 4. The method of any of examples 1-3, wherein determining one or more matching pieces of text comprises determining one or more exact matches with the specified text.

Example 5. The method of any of examples 1-4, wherein determining one or more matching pieces of text comprises determining one or more exact matches with a spell-corrected version of the specified text.

Example 6. The method of any of examples 1-5, wherein determining one or more matching pieces of text comprises determining one or more non-exact matches with the specified text.

Example 7. The method of example 6, wherein the non-exact match is based on entity extraction techniques.

Example 8. The method of example 6, wherein the non-exact match is based on relationship embedding techniques.

Example 9. The method of example 6, wherein the non-exact match is based on matching synonyms.

Example 10. The method of any of examples 1-9, further comprising: ranking the matching pieces of textual content based on a relevance score; and wherein the matching pieces of textual content are presented to the client device in order of ranking.

Example 11. The method of example 10, wherein the relevance score is based on one or more of: the specified text, user preferences, user behavior, user search history, and popularity of the matching piece of textual content.

Example 12. The method of any of examples 1-11, wherein the matching pieces of textual content are presented to the client device in chronological order based on the associated timestamps.

Example 13. The method of any of examples 1-12, wherein presenting the matching pieces of textual content comprises: presenting the frame associated with each matching piece of textual content, the matching piece of textual content being visually highlighted within the presented frame.

Example 14. The method of any of examples 1-13, wherein presenting the matching pieces of textual content comprises: presenting the full textual content from the frame associated with each matching piece of textual content, the matching piece of textual content being visually highlighted within the presented full textual content.

Example 15. The method of any of examples 1-14, wherein presenting the matching pieces of textual content comprises: presenting a subset of the textual content from the frame associated with each matching piece of textual content, the matching piece of textual content being visually highlighted within the presented subset of the textual content.

Example 16. The method of example 15, further comprising: identifying, from the frame associated with each matching piece of textual content, a contextual portion of the textual content representing a context for the matching piece of textual content within a prespecified threshold distance from the matching piece of textual content, wherein the presented subset of the textual content is the contextual portion of the textual content.

Example 17. The method of example 15, wherein the presented subset is determined based on the available space within a window for presenting the subset.

Example 18. The method of any of examples 1-17, wherein presenting the matching pieces of textual content comprises: presenting one or more frames associated with the matching pieces of textual content and one or more pieces of textual content associated with the frames, the matching pieces of textual content being visually highlighted within the pieces of textual content associated with the frames.

Example 19. A communication system comprising one or more processors configured to perform the operations of: receiving video content of a communication session between a plurality of participants; extracting, via optical character recognition (OCR), a plurality of textual content from the frames of the video content, each piece of textual content comprising a timestamp representing a temporal location within the video content; receiving, from a client device associated with a user, a request to search for specified text within the video content; in response to receiving the request, determining one or more matching pieces of textual content which match to the specified text; and presenting, to the client device, the matching pieces of textual content.

Example 20. The communication system of example 19, wherein at least a subset of the plurality of textual content comprises one or more titles detected within the frames of the video content.

Example 21. The communication system of any of examples 19-20, wherein the specified text within the request comprises at least one of: one or more words, one or more phrases, one or more numbers, and one or more symbols.

Example 22. The communication system of any of examples 19-21, wherein determining one or more matching pieces of text comprises determining one or more exact matches with the specified text.

Example 23. The communication system of any of examples 19-22, wherein determining one or more matching pieces of text comprises determining one or more exact matches with a spell-corrected version of the specified text.

Example 24. The communication system of any of examples 19-23, wherein determining one or more matching pieces of text comprises determining one or more non-exact matches with the specified text.

Example 25. The communication system of example 24, wherein the non-exact match is based on entity extraction techniques.

Example 26. The communication system of example 24, wherein the non-exact match is based on relationship embedding techniques.

Example 27. The communication system of example 24, wherein the non-exact match is based on matching synonyms.

Example 28. The communication system of any of examples 19-27, further comprising: ranking the matching pieces of textual content based on a relevance score; and wherein the matching pieces of textual content are presented to the client device in order of ranking.

Example 29. The communication system of example 28, wherein the relevance score is based on one or more of: the specified text, user preferences, user behavior, user search history, and popularity of the matching piece of textual content.

Example 30. The communication system of any of examples 19-29, wherein the matching pieces of textual content are presented to the client device in chronological order based on the associated timestamps.

Example 31. The communication system of example 30, wherein presenting the matching pieces of textual content comprises: presenting the frame associated with each matching piece of textual content, the matching piece of textual content being visually highlighted within the presented frame.

Example 32. The communication system of any of examples 19-31, wherein presenting the matching pieces of textual content comprises: presenting the full textual content from the frame associated with each matching piece of textual content, the matching piece of textual content being visually highlighted within the presented full textual content.

Example 33. The communication system of any of examples 19-32, wherein presenting the matching pieces of textual content comprises: presenting a subset of the textual content from the frame associated with each matching piece of textual content, the matching piece of textual content being visually highlighted within the presented subset of the textual content.

Example 34. The communication system of example 33, wherein the one or more processors are further configured to perform the operation of: identifying, from the frame associated with each matching piece of textual content, a contextual portion of the textual content representing a context for the matching piece of textual content within a prespecified threshold distance from the matching piece of textual content, wherein the presented subset of the textual content is the contextual portion of the textual content.

Example 35. The communication system of example 33, wherein the presented subset is determined based on the available space within a window for presenting the subset.

Example 36. The communication system of any of examples 19-35, wherein presenting the matching pieces of textual content comprises: presenting one or more frames associated with the matching pieces of textual content and one or more pieces of textual content associated with the frames, the matching pieces of textual content being visually highlighted within the pieces of textual content associated with the frames.

Example 37. The communication system of any of examples 19-36, wherein presenting the matching pieces of textual content comprises: presenting the frame associated with each matching piece of textual content, the matching piece of textual content being visually highlighted within the presented frame.

Example 38. The communication system of any of examples 19-37, wherein presenting the matching pieces of textual content comprises: presenting the full textual content from the frame associated with each matching piece of textual content, the matching piece of textual content being visually highlighted within the presented full textual content.

Example 39. The communication system of any of examples 19-38, wherein presenting the matching pieces of textual content comprises: presenting a subset of the textual content from the frame associated with each matching piece of textual content, the matching piece of textual content being visually highlighted within the presented subset of the textual content.

Example 40. The communication system of example 39, wherein the one or more processors are further configured to perform the operation of: identifying, from the frame associated with each matching piece of textual content, a contextual portion of the textual content representing a context for the matching piece of textual content within a prespecified threshold distance from the matching piece of textual content, wherein the presented subset of the textual content is the contextual portion of the textual content.

Example 41. The communication system of example 39, wherein the presented subset is determined based on the available space within a window for presenting the subset.

Example 42. The communication system of any of examples 19-41, wherein presenting the matching pieces of textual content comprises: presenting one or more frames associated with the matching pieces of textual content and one or more pieces of textual content associated with the frames, the matching pieces of textual content being visually highlighted within the pieces of textual content associated with the frames.

Example 43. A non-transitory computer-readable medium containing instructions comprising: instructions for receiving video content of a communication session between a plurality of participants; instructions for extracting, via optical character recognition (OCR), a plurality of textual content from the frames of the video content, each piece of textual content comprising a timestamp representing a temporal location within the video content; instructions for receiving, from a client device associated with a user, a request to search for specified text within the video content; in response to receiving the request, instructions for determining one or more matching pieces of textual content which match to the specified text; and instructions for presenting, to the client device, the matching pieces of textual content.

Example 44. The non-transitory computer-readable medium of example 43, wherein at least a subset of the plurality of textual content comprises one or more titles detected within the frames of the video content.

Example 45. The non-transitory computer-readable medium of any of examples 43-44, wherein the specified text within the request comprises at least one of: one or more words, one or more phrases, one or more numbers, and one or more symbols.

Example 46. The non-transitory computer-readable medium of any of examples 43-45, wherein determining one or more matching pieces of text comprises determining one or more exact matches with the specified text.

Example 47. The non-transitory computer-readable medium of any of examples 43-46, wherein determining one or more matching pieces of text comprises determining one or more exact matches with a spell-corrected version of the specified text.

Example 48. The non-transitory computer-readable medium of any of examples 43-47, wherein determining one or more matching pieces of text comprises determining one or more non-exact matches with the specified text.

Example 49. The non-transitory computer-readable medium of example 48, wherein the non-exact match is based on entity extraction techniques.

Example 50. The non-transitory computer-readable medium of example 48, wherein the non-exact match is based on relationship embedding techniques.

Example 51. The non-transitory computer-readable medium of example 48, wherein the non-exact match is based on matching synonyms.

Example 52. The non-transitory computer-readable medium of any of examples 43-51, further comprising: ranking the matching pieces of textual content based on a relevance score; and wherein the matching pieces of textual content are presented to the client device in order of ranking.

Example 53. The non-transitory computer-readable medium of example 52, wherein the relevance score is based on one or more of: the specified text, user preferences, user behavior, user search history, and popularity of the matching piece of textual content.

Example 54. The non-transitory computer-readable medium of any of examples 43-53, wherein the matching pieces of textual content are presented to the client device in chronological order based on the associated timestamps.

Example 55. The non-transitory computer-readable medium of any of examples 43-54, wherein presenting the matching pieces of textual content comprises: presenting the frame associated with each matching piece of textual content, the matching piece of textual content being visually highlighted within the presented frame.

Example 56. The non-transitory computer-readable medium of any of examples 43-55, wherein presenting the matching pieces of textual content comprises: presenting the full textual content from the frame associated with each matching piece of textual content, the matching piece of textual content being visually highlighted within the presented full textual content.

Example 57. The non-transitory computer-readable medium of any of examples 43-56, wherein presenting the matching pieces of textual content comprises: presenting a subset of the textual content from the frame associated with each matching piece of textual content, the matching piece of textual content being visually highlighted within the presented subset of the textual content.

Example 58. The non-transitory computer-readable medium of example 57, wherein the one or more processors are further configured to perform the operation of: identifying, from the frame associated with each matching piece of textual content, a contextual portion of the textual content representing a context for the matching piece of textual content within a prespecified threshold distance from the matching piece of textual content, wherein the presented subset of the textual content is the contextual portion of the textual content.

Example 59. The non-transitory computer-readable medium of example 57, wherein the presented subset is determined based on the available space within a window for presenting the sub set.

Example 60. The non-transitory computer-readable medium of any of examples 43-59, wherein presenting the matching pieces of textual content comprises: presenting one or more frames associated with the matching pieces of textual content and one or more pieces of textual content associated with the frames, the matching pieces of textual content being visually highlighted within the pieces of textual content associated with the frames.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method, comprising:
receiving video content of a communication session between a plurality of participants;
extracting, via optical character recognition (OCR), a plurality of textual content from the frames of the video content, each piece of textual content comprising a timestamp representing a temporal location of the frame within the video content;
receiving, from a client device associated with a user, a request to search for specified text within the video content;
in response to receiving the request, determining one or more matching pieces of textual content which match to the specified text; and
presenting, to the client device, the matching pieces of textual content.

2. The method of claim 1, wherein at least a subset of the plurality of textual content comprises one or more titles detected within the frames of the video content.

3. The method of claim 1, wherein the specified text within the request comprises at least one of: one or more words, one or more phrases, one or more numbers, and one or more symbols.

4. The method of claim 1, wherein determining one or more matching pieces of text comprises determining one or more exact matches with the specified text.

5. The method of claim 1, wherein determining one or more matching pieces of text comprises determining one or more exact matches with a spell-corrected version of the specified text.

6. The method of claim 1, wherein determining one or more matching pieces of text comprises determining one or more non-exact matches with the specified text.

7. The method of claim 6, wherein the non-exact match is based on entity extraction techniques.

8. The method of claim 6, wherein the non-exact match is based on relationship embedding techniques.

9. The method of claim 6, wherein the non-exact match is based on matching synonyms.

10. The method of claim 1, further comprising:
ranking the matching pieces of textual content based on a relevance score; and
wherein the matching pieces of textual content are presented to the client device in order of ranking.

11. The method of claim 10, wherein the relevance score is based on one or more of: the specified text, user preferences, user behavior, user search history, and popularity of the matching piece of textual content.

12. The method of claim 1, wherein the matching pieces of textual content are presented to the client device in chronological order based on the associated timestamps.

13. A communication system comprising one or more processors configured to perform the operations of:
receiving video content of a communication session between a plurality of participants;
extracting, via optical character recognition (OCR), a plurality of textual content from the frames of the video content, each piece of textual content comprising a timestamp representing a temporal location within the video content;
receiving, from a client device associated with a user, a request to search for specified text within the video content;
in response to receiving the request, determining one or more matching pieces of textual content which match to the specified text; and
presenting, to the client device, the matching pieces of textual content.

14. The communication system of claim 13, wherein presenting the matching pieces of textual content comprises:
presenting the frame associated with each matching piece of textual content, the matching piece of textual content being visually highlighted within the presented frame.

15. The communication system of claim 13, wherein presenting the matching pieces of textual content comprises:
presenting the full textual content from the frame associated with each matching piece of textual content, the matching piece of textual content being visually highlighted within the presented full textual content.

16. The communication system of claim 13, wherein presenting the matching pieces of textual content comprises:
presenting a subset of the textual content from the frame associated with each matching piece of textual content, the matching piece of textual content being visually highlighted within the presented subset of the textual content.

17. The communication system of claim 16, wherein the one or more processors are further configured to perform the operation of:
identifying, from the frame associated with each matching piece of textual content, a contextual portion of the textual content representing a context for the matching piece of textual content within a prespecified threshold distance from the matching piece of textual content,
wherein the presented subset of the textual content is the contextual portion of the textual content.

18. The communication system of claim 16, wherein the presented subset is determined based on the available space within a window for presenting the subset.

19. The communication system of claim 13, wherein presenting the matching pieces of textual content comprises:
presenting one or more frames associated with the matching pieces of textual content and one or more pieces of textual content associated with the frames, the matching pieces of textual content being visually highlighted within the pieces of textual content associated with the frames.

20. A non-transitory computer-readable medium containing instructions comprising:
instructions for receiving video content of a communication session between a plurality of participants;
instructions for extracting, via optical character recognition (OCR), a plurality of textual content from the frames of the video content, each piece of textual content comprising a timestamp representing a temporal location within the video content;
instructions for receiving, from a client device associated with a user, a request to search for specified text within the video content;
in response to receiving the request, instructions for determining one or more matching pieces of textual content which match to the specified text; and
instructions for presenting, to the client device, the matching pieces of textual content.
